(19) United States
(12) Patent Application Publication
(10) Pub. No.: US 2014/0164439 A1
(43) Pub. Date: Jun. 12, 2014

(54) MULTI-TIERED DATABASE FOR PERSONAL DATA

(71) Applicant: Kenneth Allen Gale, Oceanside, CA (US)

(72) Inventor: Kenneth Allen Gale, Oceanside, CA (US)

(21) Appl. No.: 13/710,398

(22) Filed: Dec. 10, 2012

(51) Int. Cl. G06F 17/30

(52) U.S. Cl. CPC G06F 17/30289
USPC 707/803

(57) ABSTRACT

A two-dimensional machine-readable code is provided on a non-electronic, encoded tangible medium of a hardcopy implement. The two-dimensional machine-readable code encodes first tier data of a multi-tiered data set, and is readable by a reading mechanism of a mobile communication device. Access by the mobile communication device from the first tier data to second tier data of the multi-tiered data set is then determined and enabled, where the second tier data is stored with the first tier data on an electronic, tangible, machine-readable storage medium.

### TECHNICAL FIELD

The subject matter described herein relates to storage and access to personal information, and more particularly to a multi-tiered database in which a first tier of personal data stored in the database is accessible by a non-electronic, encoded tangible medium of a hardcopy implement.

### BACKGROUND

In some scenarios, such as an emergency or during a medical procedure, having access to personal information is very important. Conventionally, personal information can be stored in a database, and accessed in real-time by any number or type of computing systems. However, there are many government laws and regulations, particularly those that relate to privacy, that govern the storing and access of data representing personal information. These laws and regulations, as well as sometimes a personal preference, can inhibit the rapid access of personal information in the scenarios in which it is needed most.

### SUMMARY

This document describes a system and method for storing personal information as data in a database, segmenting the data into tiers, and representing first tier data as a two-dimensional code on a hardcopy implement such as a tag or a card. The hardcopy implement is kept on or near a person at all times, to provide to a third party rapid access to the first tier data and successive tiers, based on successive authorizations for such access by the third party.

In one aspect a system is provided. The system includes a multi-tiered database implemented on an electronic, tangible, machine-readable storage medium accessible by a computer processor. The multi-tiered database stores data representing personal information, the data being segmented into at least first tier data and second tier data. The system further includes a hardcopy implement having a non-electronic, encoded tangible medium that encodes the first tier data of the data representing personal information in a two-dimensional machine-readable code. The two-dimensional machine-readable code is readable by a reading mechanism of a mobile communication device, and enables access by the mobile communication device to the second tier data of the multi-tiered database on the electronic, tangible, machine-readable storage medium via a communications network.

In another aspect, a method is disclosed. The method includes providing a two-dimensional machine-readable code on a non-electronic, encoded tangible medium of a hardcopy implement. The two-dimensional machine-readable code encodes first tier data of a multi-tiered data set. The two-dimensional machine-readable code is readable by a reading mechanism of a mobile communication device. The method further includes enabling access by the mobile communication device from the first tier data to second tier data of the multi-tiered data set, the second tier data being stored with the first tier data on an electronic, tangible, machine-readable storage medium. The method further includes accessing the second tier data by the mobile communication device from the multi-tiered data set on the electronic, tangible, machine-readable storage medium via a communications network.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates the operation of a multi-tiered database;

FIG. 2 is a table showing various applications for a multi-tiered database in accordance with implementations described herein;

FIG. 3 illustrates a system for storing and accessing personal information in a multi-tiered database;

FIG. 4 is a flowchart of a method for storing and accessing personal information in a multi-tiered database.

When practical, similar reference numbers denote similar structures, features, or elements.

### DETAILED DESCRIPTION

To address these and potentially other issues with currently available solutions, methods, systems, articles of manufacture, and the like consistent with one or more implementations of the current subject matter can, among other possible advantages, provide a multi-tiered database for safe, secure storage and access of personalized information.

In particular, a multi-tiered database is provided, in which a first tier of personal data stored in the database is accessible by a non-electronic, encoded tangible medium of a hardcopy implement. In preferred implementations, the hardcopy implement is embodied as a substantially planar, rigid identifier tag (hereinafter, “ID tag”), and the non-electronic, encoded tangible medium is a two-dimensional graphical code such as a Quick Response (QR) code or other machine-readable code (hereinafter, “2D code”) provided to the ID tag. In addition, the ID tag may include, on an opposite surface, for example, non-encoded textual or alphanumeric information sufficient to identify the person or possessor, such as name, identifier number, birth date, and/or medical or physical condition descriptors.

In some preferred, exemplary implementations, the 2D code is etched, printed, engraved, or otherwise marked on the surface of the ID tag. The ID tag is preferably a relatively small hardcopy implement, and can be the size and shape of a standard credit card. Alternatively, the ID tag can be formed of a size and shape to be worn on a necklace or bracelet of a wearer. For instance, the ID tag can be square or rectangular, with sides of 0.5 inches or less to 4 inches or more. The ID tag is preferably made of a solid, rigid, non-brittle, hard, and/or resilient material such as metal, carbon fiber, laminated paper or other flexible material, or hard plastic or other synthetic material. The ID tag may include one or more apertures or tangs for being attached to another object such as a user' necklace, bracelet, wallet, mobile electronic device, key ring, or the like.

In exemplary implementations, data representing personal information about a person is formed in a database by a first party, i.e., a data administrator or even the person him or herself. The database is a structured set of data stored on an electronic medium, such as a relational database on a disk storage medium, tape storage medium, or solid state transistor medium. The data of personal information is designated as being at least first tier data and second tier data. The first tier data is encoded in the 2D code on the ID tag. Once stored and encoded, the first tier data is accessible by third parties or the person only via the 2D code on the ID tag. Such access is preferably made by a mobile electronic device, such as a smart phone or tablet computer, but which also may be a laptop computer or other mobile electronic device, and which uses a 2D code reader mechanism, such as an optical sensor, a code scanner, an image sensor, or the like, to “read” the 2D code. The mobile electronic device includes a processor executing software to process the 2D code discerned by the 2D code reader mechanism, to resolve the 2D code into the first tier data.

The first tier data contains “seeds,” such as links, codes, keys or other access mechanisms, to the second tier data. Accordingly, the second tier data is accessible by third parties or the person only via the first tier data. In preferred implementations, the data of personal information further includes a designation of third tier data, which is accessible by third parties or the person only via the second tier data. The second and/or successive tiers of data can be accessible by the mobile electronic device communicating with the database via one or more communication networks, and which may include one or more server computers for providing the second and subsequent tier data from the database.

In yet alternative implementations, the data can be designated into any number of ordinal or serial tiers, each successive tier being accessible by third parties only via a predecessor tier, and wherein the first tier of data is accessible by third parties and the person only via the 2D code on the ID tag. However, in accordance with preferred exemplary implementations, it is important to limit the number of tiers for designating only important, emergency or critical information. The system, and method of accessing the same, is particularly useful for emergency, medical, or other health-related scenarios. Access to a first tier of the database of personal information, via the non-electronic, encoded tangible medium of a hardcopy implement, provides an access point that does not require electricity, and can be carried or worn by a person and subject to any kind of environmental factors without being degraded, deformed, or destroyed.

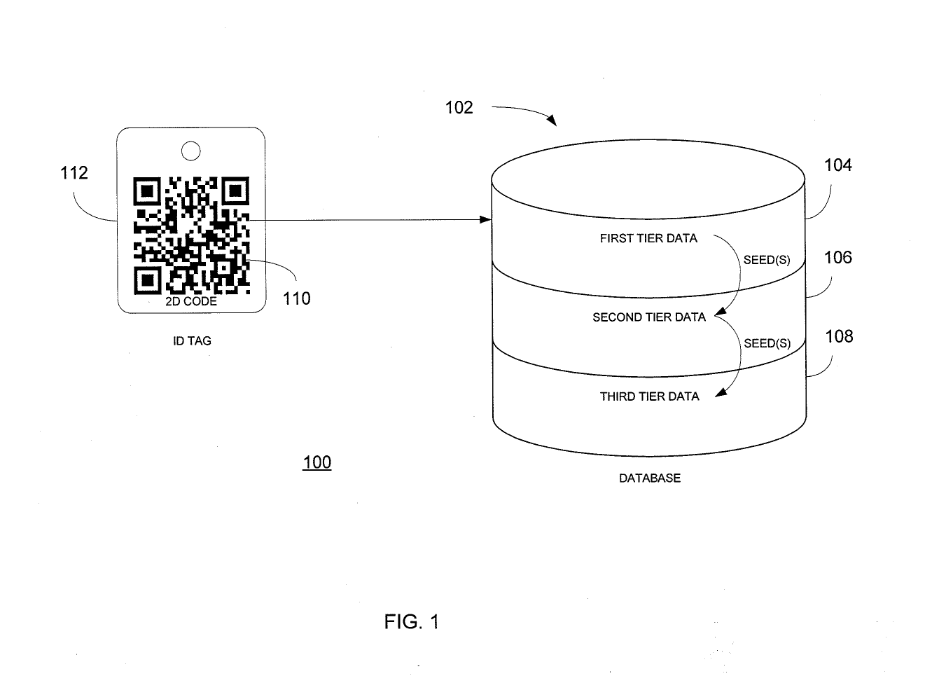

FIG. 1 illustrates a multi-tiered database system 100 in which data representing personal information about a person is stored in a database 102. The data in the database 102 is structured as at least first tier data 104 and second tier data 106. The data may further be structured as third tier data 108, or even further as higher-tiered, although in preferred implementations, the data is only structured in up to three tiers. Each successive tier of data is more detailed yet less pertinent to an emergency scenario than a predecessor tier. The first tier data 104 is encoded (i.e., as a 2D code), and provided to a non-electronic, encoded tangible medium 110 of a hardcopy implement 112 (i.e., a surface or region of a planar ID tag).

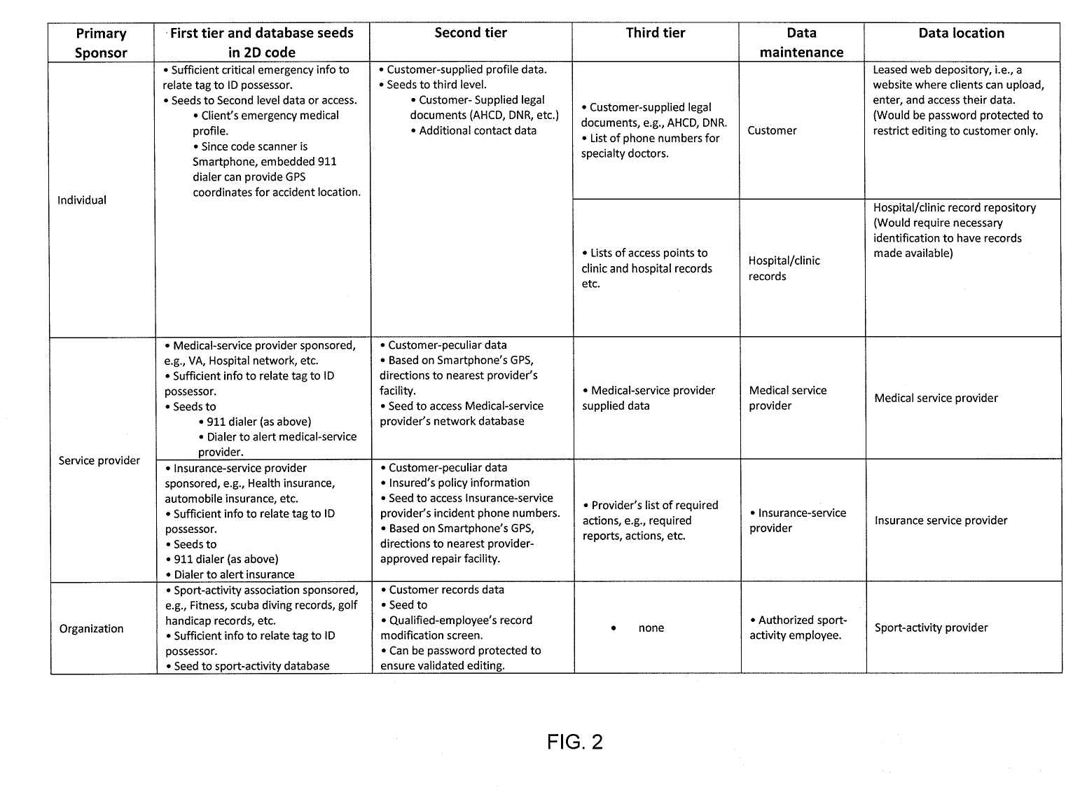

FIG. 2 is a table illustrating first tier data 104, second tier data 106 and third tier data 108 in accordance with some exemplary implementations. For example, for a multi-tiered database system 100 for storing individual data, the first tier data 104 can include sufficient critical emergency information to relate or associate the ID tag to the person represented by the data. This emergency information can include, without limitation, information about medical conditions, blood type, age, gender, birth date, name, religion, medical preferences, truncated or summary of the person's profile or physical attributes, or the like. The first tier data 104 can also include an emergency contact trigger for use by a mobile communication device, such as a smart phone or tablet computer, operated by a licensed or approved third party, such as an emergency medical technician (EMT), doctor, nurse, or police officer. The emergency contact trigger can include, for example, a 911 dialer, a texting engine, a location-based services generator such as a GPS or other coordinate-based locator, and/or emergency instructions. The emergency instructions can include brief tutorial or instructional media such as a video or graphics or text, and may include an interview to solicit further information from a user of the mobile communication device. The first tier data 104 also includes one or more seeds to the second tier data 106.

In accordance with the exemplary implementations just described, in the context of individual data, the second tier data 106 can include customer-supplied profile information, and more detailed information about the person's medical conditions, including medical history or records, as well as contact information to other third parties such as hospitals, doctors, urgent care facilities, service providers, or such. The contact information can include phone numbers, fax numbers, texting numbers, email addresses, physical addresses (which can be resolved and used by a graphical mapping application, for instance), or any other contact information.

Further in accordance with these exemplary implementations, the third tier data 108 can include customer-supplied legal documents, further contact information for other service providers to the person, and supporting documents such as guides, manuals, or other descriptive or supporting material.

In one specific example, first tier data 104 can include a designation that the person is a diabetic, the second tier data 106 can include that person's blood glucose level history and insulin-taking profile, as well as contact information to the person's endocrinologist and his or her office. The third tier data 108 can include documents of how to treat conditions of diabetes in general, as well as any other supporting document to relate to a diabetic condition. The third tier can also include access to the endocrinologist's patient records via a patient portal. Many hospitals and specialists now implement portals to provide their patients access to their records. Those of skill in the art would recognize that this specific example relates only to a subset of possible information provided by the first, second and third tier data, and that other information can be provided by various tiers, and other numbers of tiers can be provided in the multi-tiered database system 100. With reference again to FIG. 2, there is shown other examples of information provided by the first tier data 104, second tier data 106, and third tier data 108, as well as a designation of a preferred data maintenance party, and a location of the data or database.

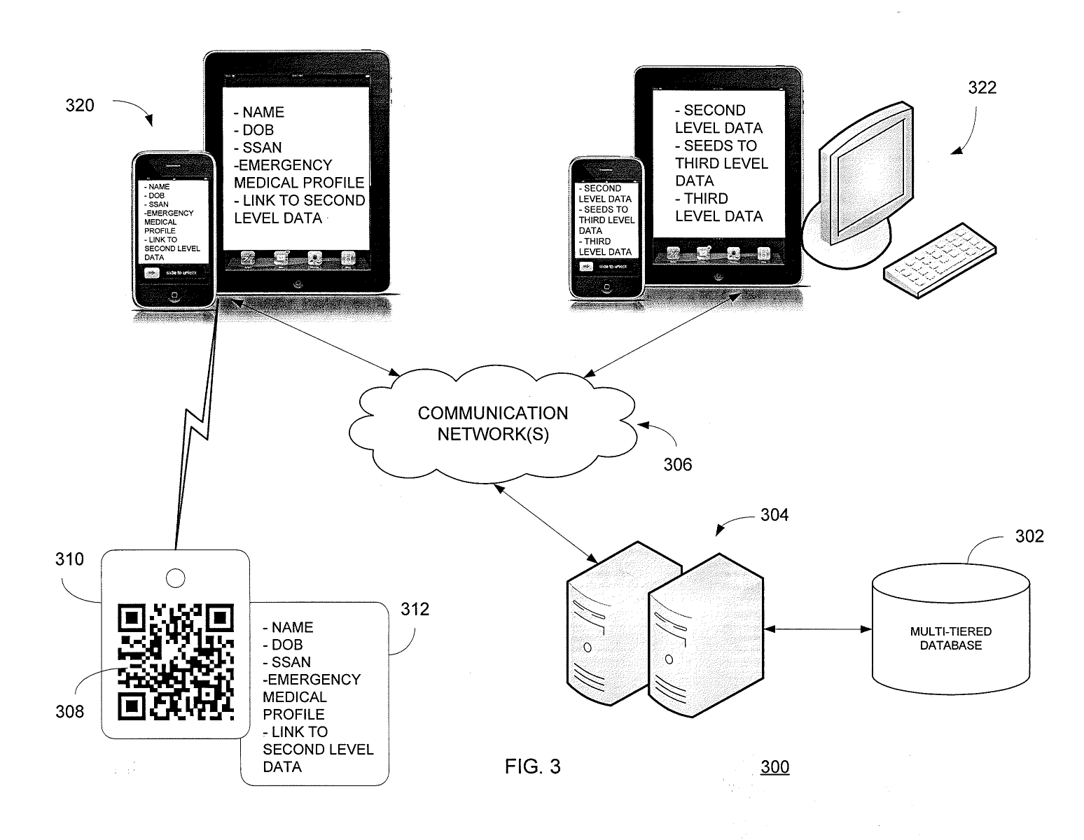

FIG. 3 illustrates a use case 300 of a multi-tiered database 302. The multi-tiered database 302 stores data representing various aspects about one or more persons. The data is organized in multiple tiers, and each tier is accessible by different mechanisms. The multi-tiered database 302 is controlled by a database management system (DBMS) executed by one or more computer systems 304. Each of the one or more computer systems 304 includes a data processor and local working memory. The computer systems 304 can be a server or server farm, a desktop personal computer, or other type of computer. The one or more computer systems 304 can access the data stored in the multi-tiered database 302, process the data, and transmit processed (or unprocessed) data to other computers via one or more communication networks 306. The communication networks 306 include local area networks (LANS), wide area networks (WANS), wireless networks, or land-line based networks, such as fiber optic cable, coaxial cable, or the like, as well as any communication protocol used for transmitting the data over the associated communication network.

The data in the database 302 is structured as at least first tier data and second tier data, and may further be structured as third tier data or more. The first tier data is encoded as a 2D code 308 on one side of an ID tag 310. Some or all of the first tier data can also be provided, un-encoded as text or other alphanumeric information, on an opposite side 312 of the ID tag, or even on the same side as the 2D code. The ID tag is provided as the only way to access the first tier data of the multi-tiered database 302 by one or more mobile communication devices 320 operated by third parties. In other words, the one or more mobile communication devices 320 can only access the first tier data by being in proximity to the ID tag, as the first tier data, in the first instance, is not transmitted from the multi-tiered database 302 and computer systems 304 via the one or more communication networks 306.

In a specific exemplary implementation, the ID tag 310 is kept on or near the person represented by the data in the database 302. The 2D code 308 on the ID tag 310 is scanned or otherwise “read” by a reader mechanism used by a mobile communication device 320. The reader mechanism can be a barcode scanner or QR code scanner and associated application software for processing the encoded data read by the scanner. The mobile communication device 320 processes the encoded data to display the first tier data in a graphical display or graphical user interface (GUI) in a display. The first tier data includes seeds or links to second tier data, which is accessed from the multi-tiered database 302 by the mobile communication device 320 via the communication network(s) 306 and computer systems 304. The second tier data is then also displayed on the mobile communication device 320, or can be transmitted to other third party computers 322, such as other smart phones, tablet computers, laptop computers, desktop computers, server computers, or the like. In still other implementations, the second tier data includes seeds or links to third tier data, which in turn can include seeds or links to further successive tiers of data.

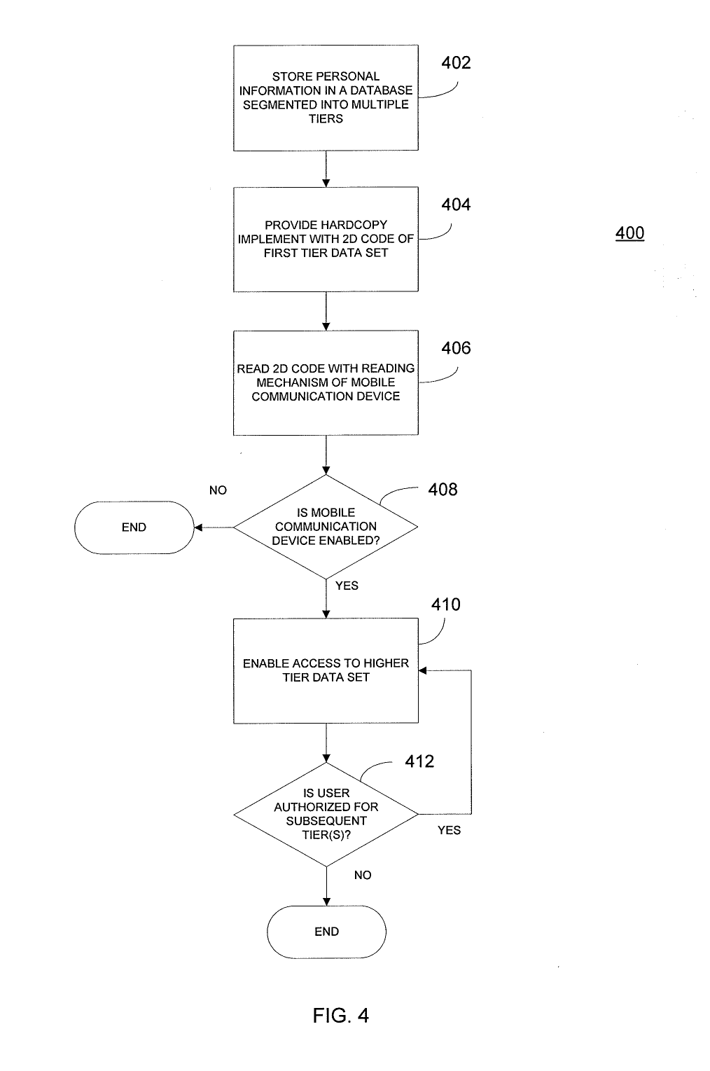

FIG. 4 is a flowchart of a method 400 for storing and accessing personal information in a multi-tiered database. At 402, the personal information is stored as data in a database. The database can be any of a relational or other type of database, and the data representing the information can be segmented into multiple tiers. The tiers can be assigned by level of importance, by a security designator, by privacy level, by access level, by level of detail, or by any other assignment or hierarchical schema. Once designated, a first tier data-set of the data in the database is determined. At 404, a non-electronic, encoded tangible medium of a hardcopy implement, such as is described above, is provided with a two-dimensional machine-readable code, such as a QR code, bar code, or other two-dimensional code that can be printed, etched, or otherwise displayed on the tangible medium of the hardcopy implement.

At 406, the two-dimensional machine-readable code is read by a reading mechanism of a mobile communication device. For instance, the reading mechanism can be a scanner and bar-code application reader application, either or both of which are running on the mobile communication device. The mobile communication device can be a portable scanner, a mobile phone, a laptop computer, or even a computer resident on a vehicle such as an ambulance, a police vehicle, a fire truck, or other emergency response vehicle. At 408, it is determined whether the mobile communication device is enabled to decode the first tier dataset from the hardcopy implement. If not, the data set will not be decoded or accessible by a user of the mobile communication device or reading mechanism, and the method ends. If yes, then at 410 the reading mechanism and/or mobile communication device will be enabled and allowed to read, decode, and then display the dataset, which may or may not be the same as text-based information displayed on another part of the hardcopy implement.

An advantage to being able to encode, and then decode, the first tier dataset into the two-dimensional machine-readable code is the ability to embed hypertext links or other pointers that are instantly accessible via the mobile communication device, and by which a user can access subsequent tiers of the database of personal information. At 412, it is determined whether a user of the mobile communication device has authorization or access to any subsequent tier of information. The determination can be made by the reader application, or by an associated application running on the mobile communication device. Alternatively, the determination can be made over a network, such as by a server connected with the database, which receives a request to access a subsequent tier, and looks up matching information such as a device ID, user ID, or the like, to determine whether the user of the mobile communication device can be provided access to the subsequent tiers of datasets. If yes, such access is enabled, and the subsequent tier dataset is delivered to a desired computing device. If not, the method ends.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “electronic machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as a liquid crystal display (LCD) or a light emitting diode (LED) display for displaying information to the user and a keyboard and a pointing device, such as for example a mouse or a trackpad, by which the user may provide input to the computer. Other kinds of devices can be used to provide for interaction with a user as well. For example, feedback provided to the user can be any form of sensory feedback, such as for example visual feedback, auditory feedback, or tactile feedback such as using a touch-sensitive display; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed:

1. A system comprising:
a multi-tiered database implemented on an electronic, tangible, machine-readable storage medium accessible by a computer processor, the multi-tiered database storing data representing personal information, the data being segmented into at least first tier data and second tier data; and
a hardcopy implement having a non-electronic, encoded tangible medium that encodes the first tier data of the data representing personal information in a two-dimensional machine-readable code, the two-dimensional machine-readable code on the non-electronic, encoded tangible medium being readable by a reading mechanism of a mobile communication device and enabling access by the mobile communication device to the second tier data of the multi-tiered database on the electronic, tangible, machine-readable storage medium via a communications network.

2. The system in accordance with claim 1, wherein the hardcopy implement is a tag.

3. The system in accordance with claim 2, wherein the two-dimensional machine-readable code is a quick response code printed on a face of the tag.

4. The system in accordance with claim 1, wherein the personal information includes health information about a person, and wherein the first tier data includes emergency medical information related to the health information about the person.

5. The system in accordance with claim 4, wherein the second tier data includes non-emergency medical information about the person.

6. A method comprising:
providing a two-dimensional machine-readable code on a non-electronic, encoded tangible medium of a hardcopy implement, the two-dimensional machine-readable code encoding first tier data of a multi-tiered data set, the two-dimensional machine-readable code on the non-electronic, encoded tangible medium being readable by a reading mechanism of a mobile communication device; and
enabling access by the mobile communication device from the first tier data to second tier data of the multi-tiered data set, the second tier data being stored with the first tier data on an electronic, tangible, machine-readable storage medium; and
accessing the second tier data by the mobile communication device from the multi-tiered data set on the electronic, tangible, machine-readable storage medium via a communications network.

7. The method in accordance with claim 6, wherein access to the second tier data is enabled by a hypertext link encoded in the two-dimensional machine-readable code representing the first tier data.

8. The method in accordance with claim 6, wherein the two-dimensional machine-readable code is a quick response code, and wherein the reading mechanism of the mobile communication device includes a quick response code reader application.

9. The method in accordance with claim 6, wherein the personal information includes health information about a person, and wherein the first tier data includes emergency medical information related to the health information about the person.

10. The method in accordance with claim 9, wherein the second tier data includes non-emergency medical information about the person.
